(19) United States
(12) Patent Application Publication
(10) Pub. No.: US 2012/0252339 A1
(43) Pub. Date: Oct. 4, 2012

(54) AIR CONDITIONING APPARATUS

(75) Inventors: Sudha Senthil, West Bloomfield, MI (US); Kevin Marrocco, Canton, MI (US)

(73) Assignees: DENSO CORPORATION, Kariya-shi (JP); DENSO INTERNATIONAL AMERICA, INC., Southfield, MI (US)

(21) Appl. No.: 13/113,284

(22) Filed: May 23, 2011

Related U.S. Application Data
(60) Provisional application No. 61/470,182, filed on Mar. 31, 2011.

(51) Int. Cl. B60H 1/24

(52) U.S. Cl. 454/75

(57) ABSTRACT

An air conditioning apparatus having an electrical controlling unit that is configured to receive a wiper motor signal, and accumulates a wiper signal value based on the wiper motor signal. When the accumulated wiper signal value exceeds a threshold value, the electrical controlling unit stops introducing recirculation airflow in an auto selection mode, until predetermined conditions are satisfied. The air conditioning apparatus may detect rain by the wiper motor signal.

### CROSS-REFERENCE TO RELATED APPLICATIONS

This application claims the benefit of U.S. Provisional Application No. 61/470,182, filed on Mar. 31, 2011. The entire disclosure of the above application is incorporated herein by reference.

### FIELD

The present disclosure relates to an air conditioning apparatus for a vehicle having a wiper motor.

### BACKGROUND

This section provides background information related to the present disclosure, which is not necessarily prior art. Fuel economy of a vehicle may be improved, if an air conditioning apparatus for the vehicle introduces recirculated airflows sucked from a vehicle cabin. At warm ambient temperatures, it is much more efficient to utilize the recirculated airflows, because, the recirculated airflows may be cooler than fresh outside air. Therefore, the recirculated airflows may reduce thermal load, and less energy is needed to cool the cabin air, which directly correlates to better fuel economy. Such recirculated airflows may cause fogging of the windshield. One counter measure for the fogging may be introducing fresh outside air intermittently. Introducing fresh outside air also reduces the carbon dioxide build up in the cabin.

The above air conditioning apparatus has proven satisfactory for its intended purpose, but if there is rain outside, introducing fresh outside air intermittently may be not enough duration to avoid windshield fogging.

### SUMMARY

In order to prevent windshield fogging, the present invention describes an air conditioning apparatus having an air conditioning case defining a recirculation air inlet and an outside air inlet, an introducing air switching mechanism switching an air introducing mode between a recirculation air intake mode and an outside air intake mode, and an electrical controlling unit electrically connected to the introducing air switching mechanism.

The electrical controlling unit is configured to receive a wiper motor signal, and accumulates a wiper signal value based on the wiper signal. When the accumulated wiper signal value exceeds a threshold value, the electrical controlling unit stops controlling the air switching mechanism to switch current air introducing mode to the recirculation air intake mode until predetermined conditions are satisfied. With this aspect, the air conditioning apparatus may detect rain by the wiper motor signal, and when it is raining, the air conditioning apparatus may avoid introducing recirculated airflow.

Another aspect of this disclosure is, the wiper signal value is a period of wiper movement. The accumulated period of wiper movement adequately represents current condition of weather.

Yet, another aspect of this disclosure is, the accumulated wiper signal value is set to an initial value, when the accumulated wiper signal value exceeds the threshold value. With this aspect, the air conditioning apparatus may be able to keep monitoring the weather.

Still yet, another aspect of this disclosure is, the electrical control unit starts accumulating the wiper signal value again, after the accumulated wiper signal value is set to an initial value, and stops controlling the air switching mechanism to switch the air introducing modes to the recirculation air intake mode until when a certain time period has passed since the accumulated wiper signal value is set to the initial value, as long as the accumulated wiper signal value has not reached the threshold value again within the certain time period. With this aspect, the air conditioning apparatus may control the air switching mechanism in accordance with the latest weather.

The present invention also describes an air conditioning apparatus having an air conditioning case equipped with a recirculation air inlet and an outside air inlet, an introducing air switching mechanism, switching an air introducing mode between a recirculation air intake mode and an outside air intake mode, a means for setting air intake mode, a means for providing auto air recirculation mode, for introducing recirculation air intake mode with periodically introducing outside airflows to the air conditioning case, and a means for accumulating a wiper motor signal value. The means for providing auto air recirculation mode does not activate, when a wiper accumulated wiper signal value exceeds a threshold value. With this aspect, the air conditioning apparatus may detect rain by the wiper motor signal, and when it is raining, the auto air recirculation mode will not be activated.

The present disclosure further describes a method for controlling an air conditioning apparatus for a vehicle. The vehicle has a wiper motor, a cabin, means for setting air intake mode, and means for providing auto air recirculation mode. The method comprises steps of: determining an air introducing mode, accumulating a wiper motor signal value, and forbidding an operation of the means for providing auto air recirculation mode, when the accumulated wiper motor signal value exceeds a threshold value. With this method, the air conditioning apparatus may detect rain by the wiper motor signal, and when it is raining, the air conditioning apparatus may avoid an operation of the means for providing auto air recirculation mode.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an air conditioning apparatus in the present disclosure;

FIG. 2 is a block diagram of an electrical control unit of the air conditioning apparatus in the present disclosure;

FIG. 3 is a graph depicting f5(TAMdisp) vs. TAMdisp.

FIG. 4 is a table describing behavior of Wiper_Flag_TIMER;

FIG. 5 is a table describing behavior of ECON_REC_TIMER;

FIG. 6 is a part of a flowchart depicting a method for detecting rain by the wiper motor signal in the present disclosure;

FIG. 7 is another part of a flowchart depicting a method for detecting rain by the wiper motor signal in the present disclosure, and

FIG. 8 is a flowchart depicting a method for controlling an introducing air switching mechanism in auto air selection mode in the present disclosure.

Corresponding reference numerals indicate corresponding elements throughout the several views of the drawings.

### DETAILED DESCRIPTION

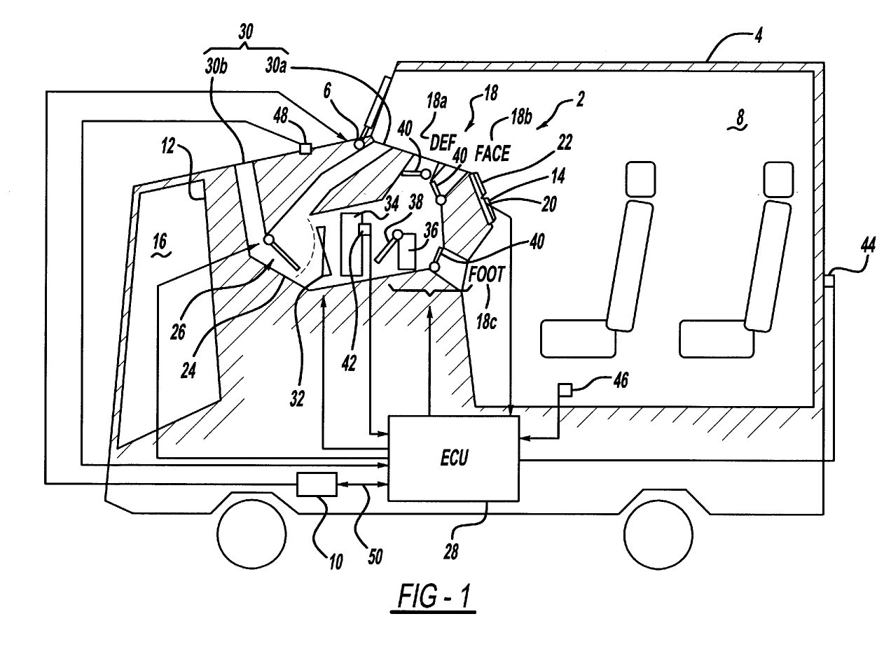

The preferred and other embodiments will now be described more fully with reference to FIGS. 1-8 of the accompanying drawings. FIG. 1 is a schematic view of an air conditioning apparatus 2 for a vehicle 4 in the present disclosure. The vehicle 4 has a wiper motor 6 and a cabin 8. The wiper motor 6 is operated by a wiper motor ECU 10 and the wiper motor ECU 10 operates the wiper motor 6 in accordance with driver's operation or signals from a rain sensor (not shown) equipped with the vehicle. The wiper motor ECU 10 generates a wiper motor signal when the wiper motor ECU 10 operates the wiper motor 6.

In this embodiment, the air conditioning apparatus 2 is disposed between a dash panel 12 and an instrument panel 14. The dash panel 12 is a partition wall between an engine compartment 16 and the cabin 8, wherein the instrument panel 14 is located in the cabin 8. The instrument panel 14 has air outlets 18 of the air conditioning apparatus 2, various input means 20 for the vehicle operation, and various display means 22 such as speed meter, fuel meter, and tachometer. The air outlets 18 of the air conditioner may have a defroster outlet 18a, a face outlet 18b, and a foot outlet 18c.

The air conditioning apparatus 2 comprises an air conditioning case 24, an introducing air switching mechanism 26, and an electrical controlling unit 28. The air conditioning case 24 defines an air passage from air inlets 30 to the defroster outlet 18a, the face outlet 18b, and the foot outlet 18c. The air inlets 30 are a recirculation air inlet 30a and an outside air inlet 30b. The recirculation air inlet 30a is opened to an inside space of the cabin 8. The outside air inlet 30b is opened to an outside space of the cabin 8. The introducing air switching mechanism 26 is located in the air conditioning case 24. The introducing air switching mechanism 26 switches an air introducing mode between a recirculation air intake mode and an outside air intake mode.

The recirculation air intake mode introduces more recirculated airflows from the recirculation air inlet 30a relative to outside airflows from the outside air inlet 30b. The outside air intake mode introducing more the outside airflows relative to the recirculation airflows. The various input means 20 may include means for setting air intake mode. The means for setting intake air mode sets either one of recirculation air intake mode, outside air intake mode, or auto selection mode. In this embodiment, the means for setting intake air mode is a mode-setting switch on the instrument panel 14.

The air conditioning case 24 accommodates a blower fan 32, a cooling heat exchanger 34, a heating heat exchanger 36, an air-mixing door 38, and a plurality of mode doors 40. The blower fan 32 creates airflows in the air conditioning case 24. The cooling heat exchanger 34 may be an evaporator 34 of a refrigeration cycle. The evaporator 34 may have an evaporator temperature sensor 42, the evaporator temperature sensor 42 detecting the temperature of evaporator fins. The heating heat exchanger 36 may be a heater core 36, in which coolant of an engine cooling circuit flows. The air-mixing door 38 is located between the evaporator 34 and the heater core 36. The air-mixing door 38 changes the ratio between airflows passing through the heater core 36 and airflows bypassing the heater core 36. The plurality of mode doors 40 are disposed on a down stream side of the heater core 36. The plurality of mode doors 40 controls the airflows from the defroster outlet 18a, the face outlet 18b, and the foot outlet 18c.

The vehicle 4 also is equipped with an ambient temperature sensor 44, a room temperature sensor 46, and an air quality sensor 48. The ambient temperature sensor 44 detects temperature of outside air, the room temperature sensor 46 detects temperature in the cabin 8, and the air quality sensor 48 detects poisonous substances in contained in the outside air, such as NO_{X} or Hydrocarbons.

The electrical controlling unit 28 is electrically connected to the introducing air switching mechanism 26, the instrument panel 14, actuators for the air-mixing door 38 and the plurality of mode doors 40, the blower fan 32, the ambient temperature sensor 44, the room temperature sensor 46, the evaporator temperature sensor 42, and the air quality sensor 48. Also, the electrical controlling unit 28 is electrically connected to the wiper motor ECU 10 via a vehicle network 50. The electrical controlling unit 28 to be configured to receive a wiper motor signal.

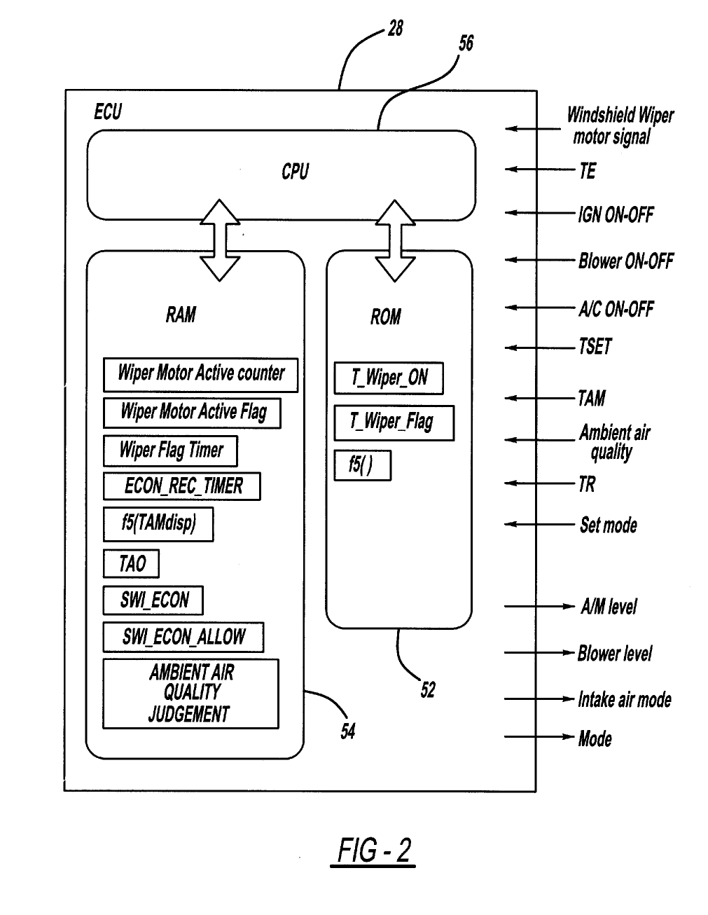

Turning to FIG. 2, FIG. 2 is a block diagram of the electrical control unit 28 of the air conditioning apparatus 2 in the present disclosure. FIG. 2 also shows input signals and output signals for the electrical control unit 28.

The input signals may include a Windshield Wiper motor signal generated by the wiper motor ECU 10, temperature of the evaporator fins (TE) detected by the evaporator temperature sensor 42, temperature of the outside air (TAM) detected by the ambient temperature sensor 44, ambient air quality detected by the ambient air quality sensor 48, and room temperature (TR) detected by the room temperature sensor 46. The input signals also include Set mode, IGN ON-OFF, Blower ON-OFF, A/C ON-OFF, TSET, and in this embodiment, these input signals are imputed by driver or passengers of the vehicle 4 via the instrument panel 14.

The Set mode represents how to distribute conditioned air into the cabin 8, and the Set mode may be one of face mode, bi-level mode, foot mode, foot-def mode, defroster mode, or auto mode. In face mode, the conditioned air is distributed mainly from the face outlet 18b. In bi-level mode, the conditioned air is distributed mainly from the face outlet 18b and the foot outlet 18c. In foot mode, the conditioned air is distributed mainly from foot outlet 18c. In foot-def mode, the conditioned air is distributed mainly from foot outlet 18c and defroster outlet 18a. In defroster mode, the conditioned air is distributed mainly from defroster outlet 18a. In auto mode, the electrical control unit selects either one of the above air distribution modes.

IGN ON-OFF represents the driver or passenger turning on and off an ignition switch of the engine. Blower ON-OFF represents the driver or passenger turning on and off the blower fan 32. A/C ON-OFF represents the driver or passenger turning on/off a compressor of the refrigeration cycle. TSET represents a temperature which the driver or passenger set as an intended temperature.

The electrical control unit 28 has a read only memory (ROM) 52, a random access memory (RAM) 54, and a central computing unit (CPU) 56. The ROM 52 stores various predetermined threshold parameters and equations. The RAM 54 temporary stores various calculated parameters calculated by the CPU 56. The CPU 56 executes various calculations and output signals for controlling the air conditioning apparatus 2 based on the inputted signals and parameters stored in the ROM 52 or RAM 54.

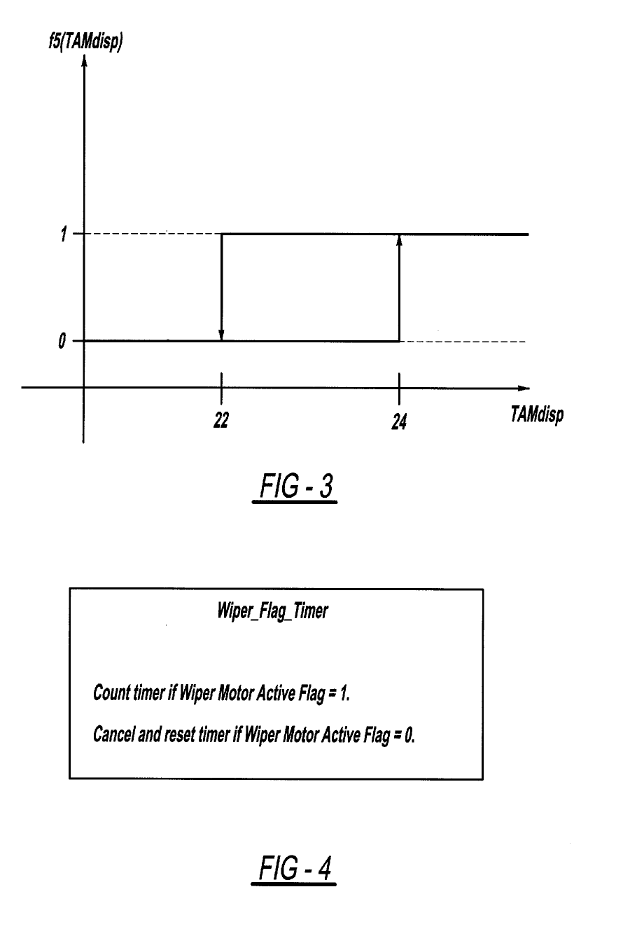

More specifically, the ROM 52 stores “T_Wiper_ON,” “T_Wiper_Flag,” and “f5(TAMdisp).” “T_Wiper_ON” is a predetermined threshold value for determining if an accumulated wiper signal value represents rain or not. In this embodiment, the accumulated wiper signal is an accumulated time period of wiper movement, and the “T_Wiper_ON” is 40 sec. “T_Wiper_ON” may be calibratable up to 1000 sec. “T_Wiper_Flag” is also a predetermined threshold value for when to determine if it is raining after once determining a rain condition. In this embodiment, the “T_Wiper_Flag” is 15 min. “T_Wiper_Flag” may be calibratable up to 50 min. “f5(TAMdisp)” represents a predetermined equation for determining if the temperature of the outside air is high or not high. FIG. 3 is a graph depicting f5(TAMdisp) vs. TAMdisp.

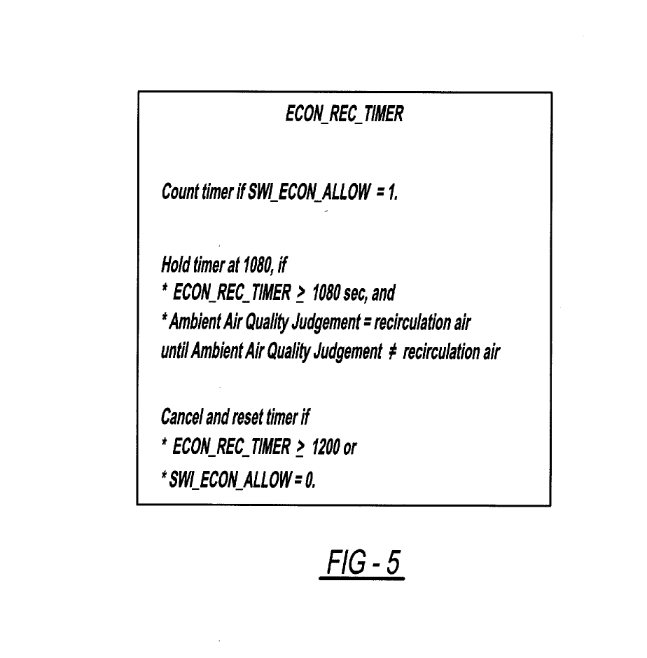

Going back to FIG. 2, The RAM 54 temporarily stores “Wiper Motor Active counter,” “Wiper motor Active Flag,” “Wiper Flag Timer,” “ECON_REC_TIMER,” “f5(TAMdisp),” “TAO,” “SWI_ECON,” “SWI_ECON_ALLOW,” and “AMBIENT AIR QUALITY JUDGEMENT.” “Wiper Motor Active counter” represents the accumulated wiper signal value, in this embodiment, which is an accumulated time period of wiper moving. “Wiper motor Active Flag” represents if it may rain or not based on the accumulated wiper signal value. “Wiper Flag Timer” represents the time period since the determination of rain. “ECON_REC_TIMER” represents the time period since the auto air recirculation mode has been set, which will be explained later. FIG. 4 is a table describing the behavior of Wiper_Flag_TIMER. FIG. 5 is a table describing behavior of ECON_REC_TIMER.

Referring back to FIG. 2, “f5(TAMdisp)” represents a value calculated by CPU 56 based on the temperature of the outside air (TAM) and “f5 (TAMdisp).” In this embodiment, TAMdisp is calculated based on the TAM. “TAO” represents the target temperature of outlet air. TAO is continuously calculated based on TAM, TSET, TE, and other parameters. Electrical control unit 28 controls the blower fan 32, the air-mixing door 38, a plurality of mode doors 40, and compressor based on the TAO. “SWI_ECON” represents the position of the air switching mechanism. “SWI_ECON=100%” means 100% outside air. In other words, “SWI_ECON=100%” means to open the outside air inlet 30b and close the recirculation air inlet 30a. “SWI_ECON=0%” means to open the recirculation air inlet 30a and close the outside air inlet 30b. “SWI_ECON_ALLOW” represents if the Electrical control unit 28 is performing auto air recirculation mode, which is periodically introducing outside airflows to the cabin during the recirculation air intake mode. “AMBIENT AIR QUALITY JUDGEMENT” represents whether if the air quality detected by the ambient air quality sensor is poor or not compared to the recirculated airflow. Air quality of the recirculated airflow may be detected by another air quality sensor disposed in the cabin.

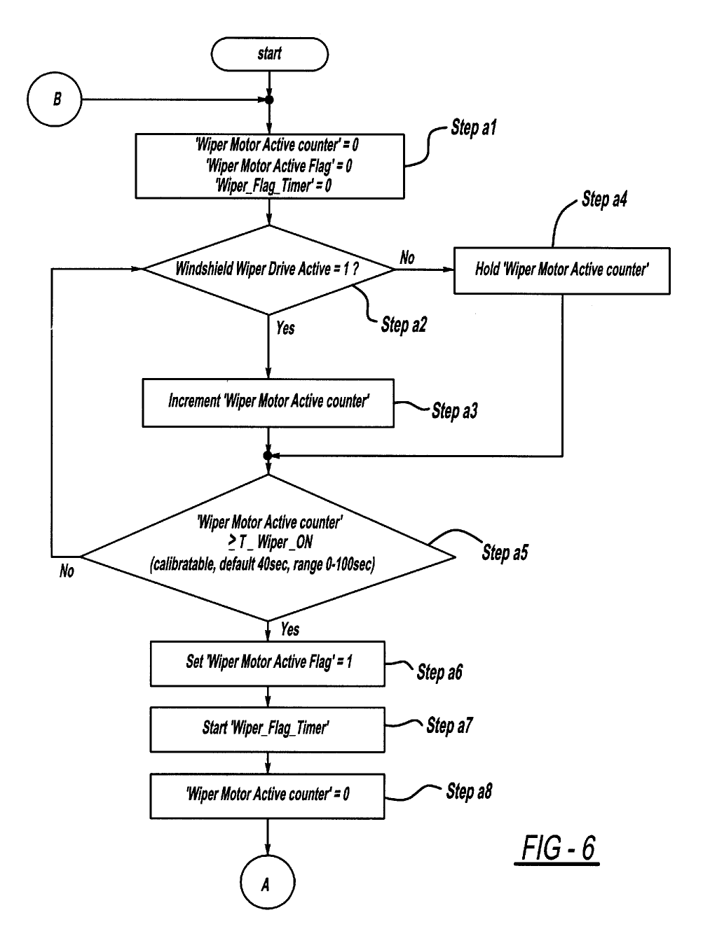

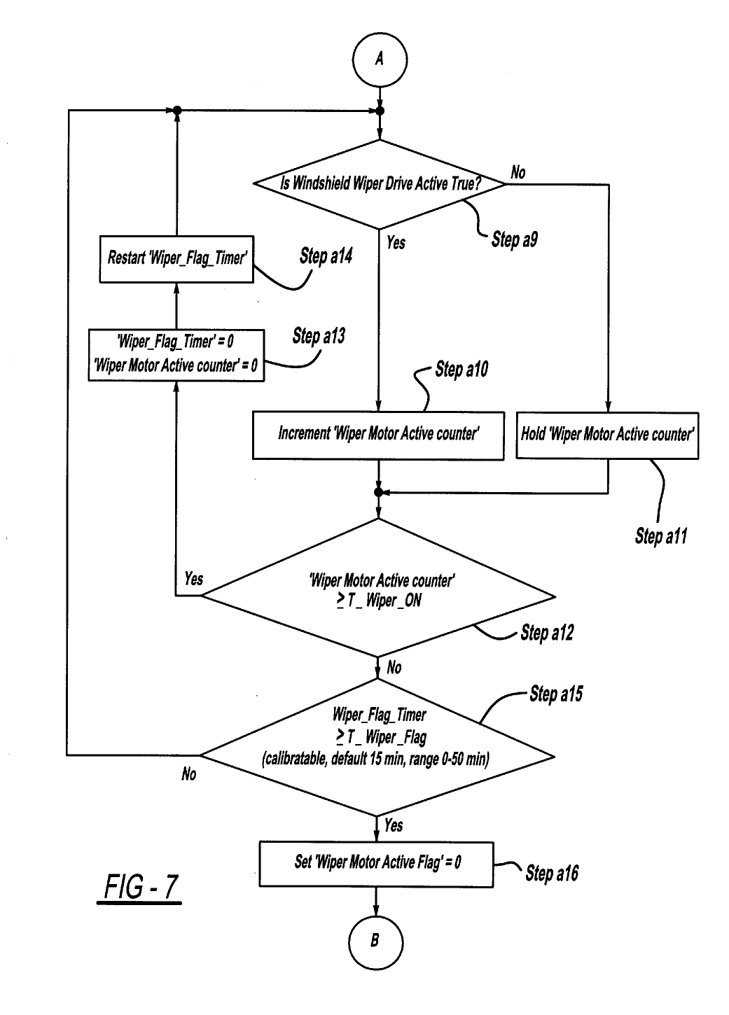

Turning to FIG. 6 and FIG. 7, FIG. 6 and FIG. 7 show a flowchart depicting a method for detecting rain by the wiper motor signal in the present disclosure. This subroutine may be executed by the CPU 56 in parallel with other subroutines. CPU 56 starts its calculation from FIG. 6, in step a1, the CPU 56 initializes “Wiper Motor Active counter,” “Wiper Motor Active Flag,” and “Wiper_Flag_Timer” as zero, and proceeds to step a2.

In step a2, CPU 56 determines if the “Windshield Wiper Drive Active” true (1) or not. The “Windshield Wiper Drive Active” represents Wiper motor signal. If the “Windshield Wiper Drive Active” is true (1), i.e. the wiper is moving, and CPU 56 proceeds to step a3, otherwise, proceeds to step a4.

In step a3, CPU 56 increments the “Wiper Motor Active counter” by accumulating the time period which has been passed since the latest determination of step a2. Then, CPU 56 proceeds to step a5. In step a4, CPU 56 holds the “Wiper Motor Active counter,” then proceeds to step a5.

In step a5, CPU 56 determines if the “Wiper Motor Active counter” is equal to or greater than the “T_Wiper_ON,” or not. As described above, in this embodiment, the “T_Wiper_ON” is a predetermined threshold value for determining if an accumulated wiper signal value represents rain or not. Again, in this embodiment, the “T_Wiper_ON” is 40 sec and the “T_Wiper_ON” may be calibratable up to 1000 sec. If the “Wiper Motor Active counter” is equal to or greater than the “T_Wiper_ON,” CPU 56 proceeds to step a6, otherwise returns to step a2.

In step a6, CPU 56 recognizes that it may rain, and sets the “Wiper Motor Active Flag”=1. Then, CPU 56 proceeds to step a7. In step a7, CPU 56 starts the “Wiper_Flag_Timer,” then, proceeds to step a8. In step a8, CPU 56 sets the “Wiper Motor Active counter'=0, then, proceeds to step a9 depicted in FIG. 7. In step a9, CPU 56 determines again if the “Windshield Wiper Drive Active” is true (1) or not. If the “Windshield Wiper Drive Active” is true (1), CPU 56 proceeds to step a10, otherwise, proceeds to step a11.

In step a10, CPU 56 increments the “Wiper Motor Active counter” by accumulating the time period, which has been passed since the latest determination of step a9. Then, CPU 56 proceeds to step a12. In step a11, CPU 56 holds the “Wiper Motor Active counter,” then proceeds to step a12.

In step a12, CPU 56 determines if the “Wiper Motor Active counter” is equal to or greater than the “T_Wiper_ON,” or not. If the “Wiper Motor Active counter” is equal to or greater than the “T_Wiper_ON,” CPU 56 proceeds to step a13, otherwise proceeds to step a15. In step a13, CPU 56 sets “Wiper Flag_Timer” and “Wiper Motor Active counter”=0, then proceeds to step a14. In step a14, CPU 56 restarts “Wiper_Flag_Timer,” then returns to step a9. In step a 15, CPU 56 determines if the “Wiper_Flag_Timer” is equal to or greater than the “T_Wiper_Flag,” or not. If the “Wiper_Flag_Timer” is equal to or greater than the “T_Wiper_Flag,” CPU 56 proceeds to Step a16, other wise returns to step a9. In step a16, CPU 56 sets the “Wiper Motor Active Flag” to 0, then returns to step a1 depicted in FIG. 6.

In this embodiment, the electrical control unit comprises a means for accumulating a wiper motor signal value. The wiper motor signal represents a movement of the wiper motor 6. The wiper signal value is a period of wiper movement. The electrical controlling unit accumulates a wiper signal value based on the wiper signal, and the accumulated wiper signal value becomes initial value, when the accumulated wiper signal value exceeds the threshold value.

The electrical control unit starts accumulating the wiper signal value again, once it has stopped controlling the air switching mechanism. The predetermined conditions to allow air recirculation are when a certain time period has passed since the electrical controlling unit stopped controlling the air switching mechanism, and also when the accumulated wiper signal value has not reached the threshold value again.

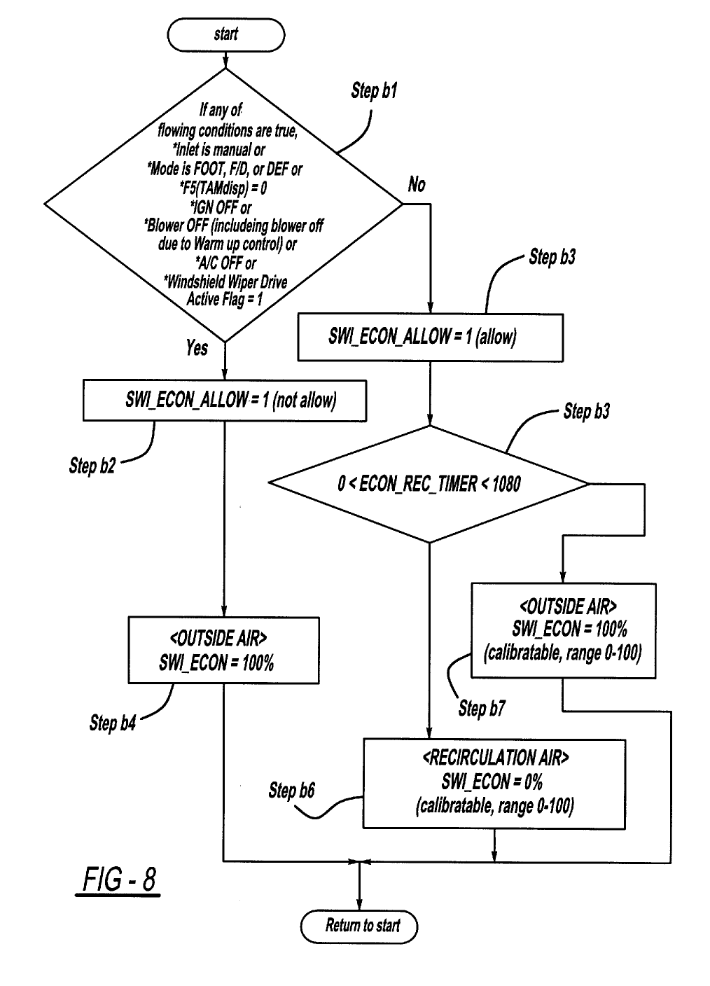

Turning to FIG. 8, FIG. 8 shows a flowchart depicting a method for controlling the introducing air switching mechanism in auto air selection mode. In this embodiment, this auto air selection mode is a means for providing auto air recirculation mode. This subroutine may be executed by the CPU 56 in parallel with other subroutines. Starting from step b1, the CPU 56 determines if any one of following conditions: inlet is manual, Mode is Foot, Foot/Def, or Defrost, IGN is OFF, Blower OFF, A/C OFF, or Windshield Wiper Drive Active Flag=1, are true or not. If any one of the conditions are true, CPU 56 proceeds to step b2, otherwise, it proceeds to step b3.

In step b2, CPU 56 sets “SWI_ECON_ALLOW”=0, then proceeds to step b4. The “SWI_ECON_ALLOW”=0 represents ECU 58 is not allowed to recirculate cabin air in the auto selection mode. In step b4, CPU 56 sets “SWI_ECON”=100%, then returns to the start. As described above, “SWI_ECON=100%” means 100% outside air.

In step b3, CPU 56 sets “SWI_ECON_ALLOW”=1, then proceeds to step b5. The “SWI_ECON_ALLOW”=1 represents ECU 58 is allowed to recirculate cabin air in the auto selection mode. In step b5, CPU 56 determines if the value of the “ECON_REC_TIMER” is between 0 and 1080, the behavior of the “ECON_REC_TIMER” being described in FIG. 5. If the value of the ECON_REC_TIMER is between 0 and 1080, CPU 56 proceeds to step b6, otherwise, it proceeds to step b7. In step b6, CPU 56 sets “SWI_ECON”=0%, then returns to the start. In step b7, CPU 56 sets “SWI_ECON”=100%, then returns to the start.

With the above embodiment, the air conditioning apparatus 2 may detect rain by the wiper motor signal, and when it is raining, the air conditioning apparatus 2 may avoid introducing recirculated airflow. Moreover, in the embodiment described above, the wiper signal value is a period of wiper movement, however, the present disclosure does not limit the wiper signal value as the period of wiper movement. The number of wiper movement can also be used as the wiper signal value.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An air conditioning apparatus for a vehicle having a wiper motor and a cabin comprising:
an air conditioning case having a recirculation air inlet opened to an inside space of the cabin, and an outside air inlet opened to an outside space of the cabin;
an introducing air switching mechanism located in the air conditioning case and switching an air introducing mode between a recirculation air intake mode introducing recirculated airflows from the recirculation air inlet rather than outside airflows from the outside air inlet, and an outside air intake mode introducing the outside airflows rather than the recirculation airflows, and
an electrical controlling unit electrically connected to the introducing air switching mechanism,
wherein,
the electrical controlling unit is configured to receive a wiper motor signal,
the wiper motor signal represents a movement of the wiper motor,
the electrical controlling unit accumulates a wiper signal value based on the wiper signal, and
when the accumulated wiper signal value exceeds a threshold value, the electrical controlling unit stops controlling the air switching mechanism to switch the air introducing modes to the recirculation air intake mode until predetermined conditions are satisfied.

2. The air conditioning apparatus according to claim 1, wherein, the wiper signal value is a period of wiper movement.

3. The air conditioning apparatus according to claim 1, wherein, the accumulated wiper signal value is reset to an initial value when the accumulated wiper signal value exceeds the threshold value.

4. The air conditioning apparatus according to claim 3, wherein,
the electrical control unit starts accumulating the wiper signal value again, after the accumulated wiper signal value is reset to the initial value, and
the electrical control unit stops controlling the air switching mechanism to switch the air introducing modes to the recirculation air intake mode until when a certain time period has passed since the accumulated wiper signal value is reset to the initial value, if the accumulated wiper signal value has not reached the threshold value again within the certain time period.

5. An air conditioning apparatus for a vehicle having a wiper motor and a cabin comprising:
an air conditioning case having a recirculation air inlet connected to an inside space of the cabin and an outside air inlet connected to an outside space of the cabin;
an introducing air switching mechanism located in the air conditioning case and switching an air introducing mode between a recirculation air intake mode introducing more recirculated airflows from the recirculation air inlet relative to outside airflows from the outside air inlet, and an outside air intake mode introducing more the outside airflows relative to the recirculation airflows;
a means for setting air intake mode setting either one of the recirculation air intake mode and the outside air intake mode;
a means for providing auto air recirculation mode periodically introducing outside airflows to the air conditioning case during the recirculation air intake mode, and
a means for accumulating a wiper motor signal value,
wherein,
the means for providing auto air recirculation mode does not perform, when a wiper accumulated wiper signal value exceeds a threshold value.

6. The air conditioning apparatus according to claim 5, wherein, the wiper signal value is a period of wiper movement.

7. The air conditioning apparatus according to claim 5, wherein, the accumulated wiper signal value becomes initial value when the accumulated wiper signal value exceeds the threshold value.

8. A method for controlling an air conditioning apparatus for a vehicle having a wiper motor, a cabin, means for setting air intake mode setting to either one of a recirculation air intake mode and an outside air intake mode, and means for providing auto air recirculation mode to periodically introduce outside airflows to the cabin during the recirculation air intake mode, the method comprising steps of:
determining an air introducing mode;
accumulating a wiper motor signal value; and
forbidding an operation of the means for providing auto air recirculation mode, when the accumulated wiper motor signal value exceeds a threshold value.

9. The method for controlling the air conditioning apparatus according to claim 8, wherein, the accumulated wiper motor signal value is set to an initial value when the accumulated wiper signal value exceeds the threshold value.
